(19) United States
(12) Patent Application Publication
(10) Pub. No.: US 2012/0078511 A1
(43) Pub. Date: Mar. 29, 2012

(54) METHOD AND APPARATUS FOR PROVIDING DIRECTIONAL NAVIGATION INDICATION

(75) Inventor: Seong Hong LIM, Singapore (SG)

(73) Assignees: PANASONIC SEMICONDUCTOR ASIA PTE., LTD., Singapore (SG); PANASONIC CORPORATION, Osaka (JP)

(21) Appl. No.: 12/891,995

(22) Filed: Sep. 28, 2010

(51) Int. Cl. G01C 21/36

(52) U.S. Cl. 701/437

(57) ABSTRACT

A method and apparatus to enhance the direction navigation capabilities of GPS-enabled devices, through the use of light indicators is proposed. The light indicators are positioned on the top, bottom, and sides of the GPS screen. The light indicators blink at different rates relatively to a distance to a destination. The light indicators show various effects to indicate various instructions, such as to go forward direction, to go onto an overhead bridge, to enter into an underground tunnel.

### BACKGROUND OF THE INVENTION

(1) Field of the Invention

The present invention relates to a GPS navigation system and, more particularly, to an apparatus for providing directional navigation indication using a GPS signal.

(2) Description of Related Art

Currently, global positioning system (GPS)-enabled devices such as GPS-equipped smart phones and dedicated portable navigation devices (PNDs) may be used to provide directional navigation guidance to users to reach to their desired destinations. Typically, such devices would have pre-installed maps in the devices, and such maps would be displayed on the screen, together with other information contents such as direction indications on the screen itself. Some manufacturers would also equip these devices with audio-assisted directional indications as enhancements to the visual indications.

However, there are some limitations to these current methods of directional displays. Firstly, for the GPS-equipped smart phones, users using it for driving will have a hard time focusing on the information contents such as directions on the small screen display, while focusing on the road condition at the same time. This could lead to loss of focus on the actual road, thus potentially further leading to road traffic accidents.

Secondly, the reflective nature of the LCD display screens used mostly by these GPS-enabled devices will cause the image to be unclear as a result of direct sunlight reflecting on its surface on a bright sunny day. This may cause the user to misinterpret the direction indications and thus go the wrong way. Alternatively, the driver could increase the backlight of the LCD screen as to make contrast with ambient light. However, this increases power consumption, thus is also undesirable.

Thirdly, the audio-assisted directional indications may actually pose more of a distraction and nuisance rather than assistance. For example, for roads with many junctions will cause the audio-assist to continuously call out instructions to the user. Also, due to long winded audio instructions, the driver may get confused as he or she cannot differentiate exactly the proper junction for his or her turning. The driver will have to refer to LCD display screen to check for the distance before he or she makes a correct turn. If a car is in high speed, the driver may pass by a correct junction before the long winded voice navigation end.

The present invention is intended to solve such problems, and it is an object of the present invention to enhance the direction navigation capabilities of the GPS-enabled devices, through the use of light indicators.

### BRIEF SUMMARY OF THE INVENTION

The purpose of this invention is to provide a method and apparatus to enhance the direction navigation capabilities of said GPS-enabled devices, through the use of light indicators.

According to the present invention, a method for providing directional navigation indication on a GPS-enabled device, comprises:

Capturing GPS signal by said GPS-enabled device;

Processing said captured GPS signal into meaningful signal; and

Outputting said meaningful signal to drive illuminating elements.

According to the present invention, the method further comprising

Disposing of light guides on said GPS-enabled device to guide the light emitted by said illuminating elements.

According to the present invention, wherein said light guides numbering at least four, namely a first light guide located at the top side of said GPS-enabled device a second light guide located on the left side of said GPS-enabled device, a third light guide located on the right side of said GPS-enabled device and a fourth light guide located at the bottom of said GPS-enabled device.

According to the present invention, the method further comprising:

Producing a fade in and out effect by said first light guide located at the top side of said GPS-enabled device, indicating the desired destination is in the forward direction.

According to the present invention, wherein said fade in and out effect changes at a higher rate as the GPS-enabled device gets nearer to the desired destination.

According to the present invention, wherein said light emitted by said illuminating elements is of the color green.

According to the present invention, an apparatus for providing directional navigation indication using a GPS signal, comprises:

a GPS signal processor which produces a guide signal including a forward signal for indicating a straight forward at a next road intersection, a right turn signal for indicating a right turn at a next road intersection, and a left turn signal for indicating a left turn at a next road intersection;

a light indicator arrangement including a top indicator provided at a top side of a predetermined space, a right indicator provided at a right side of said predetermined space, and a left indicator provided at a left side of said predetermined space; and

an indicator driver which controls the driving of said light indicator arrangement in such a manner that, said top indicator is activated in response to said forward signal, said right indicator is activated in response to said right turn signal, and said left indicator is activated in response to said left turn signal.

### BRIEF DESCRIPTION OF THE SEVERAL VIEWS OF THE DRAWINGS

FIG. 1A is a block diagram showing a first embodiment of the present invention.

FIG. 1B is a diagram showing an example of a light indicator having an illuminating element and a light guide.

FIG. 1C is a diagram showing another example of a light indicator having a plurality of illuminating elements.

FIG. 1D is a plan view showing an example of a light indicator arrangement having a plurality of light indicators.

FIG. 2A is a block diagram showing a second embodiment of the present invention.

FIG. 2B is a plan view showing an example of a light indicator arrangement provided around a display screen.

FIG. 3 is a block diagram showing a third embodiment of the present invention.

FIG. 4 is a circuit diagram showing an example of an illuminating element driver module using an LED driver.

FIG. 5 is a block diagram showing a fourth embodiment of the present invention.

FIG. 6 is a plan view of a light indicator arrangement showing a mode indicating a forward direction.

FIG. 7 is a plan view of a light indicator arrangement showing a mode indicating a left turn.

FIG. 8 is a plan view of a light indicator arrangement showing a mode indicating a right turn.

FIG. 9 is a plan view of a light indicator arrangement showing a mode indicating a U-turn.

FIG. 10 is a plan view of a light indicator arrangement showing a mode indicating an entry onto an overhead bridge or into an underground tunnel.

FIG. 11 is a plan view of a light indicator arrangement showing a mode indicating that the GPS signal is lost.

FIG. 12 is a plan view of a light indicator arrangement showing a mode indicating that the user has gone in a direction not proposed by the GPS-enabled device.

### DETAILED DESCRIPTION OF THE INVENTION

### First Embodiment

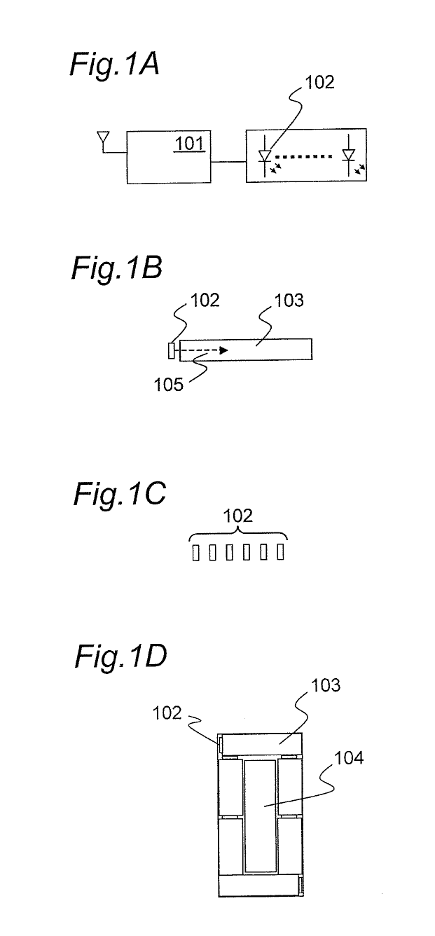

Referring to FIG. 1A, a first embodiment of a directional navigation indication apparatus on a GPS-enabled device is shown.

The directional navigation indication apparatus comprises a GPS system 101 for collecting GPS signals from a GPS signal source, such as a satellite or any GPS transmission nodes, illuminating elements 102, and light guides 103 for guiding light from the illuminating elements so as to produce a light distribution effect; and POI (point of interest) entry and verification component 104, for example a text-based entry and display screen or LCD display means.

The GPS system 101 is exemplarily represented as a GPS signal receiver and processor to output the received signal into meaningful data, where such meaningful data comprises device location and the POI (point of interest), that is, the destination of the user. The function of the antenna 100 is to capture satellite signals from the air. The GPS system converts satellite signals into actual location of the device on the earth by using a complex GPS algorithm. Furthermore, equipped with pre-installed mapping information, the GPS system is able to calculate and estimate distance between actual device location and destination. GPS system 101 has also the additional capability of driving illuminating elements 102, by having an integrated driver module.

The illuminating elements 102 are electrically coupled to the GPS system 101. Together with the light guides 103, these elements are arranged so as to produce a directional indication effect. The combination comprising an illuminating element 102 and a light guide 103 shall be referred to as a light indicator segment. How the light indicator segment works is described as follows:

Examples of illuminating elements 102 comprise light-emitting diodes (LEDs) and cold cathode fluorescent lamps (CCFLs); and examples of light guides 103 comprise light tubes and diffuser strips. The illuminating elements 102 will emit light of at least one color in proximity to the light guides 103. The light guides 103 will then spread the light emitted by the illuminating elements 102 so as to generate a seemingly uniform color distribution along the light guides 103. The illuminating element 102 can be provided at one end or at opposite ends of the light guide 103.

An exemplary implementation of this is as shown in FIG. 1B, where the face of the illuminating elements 102 from which light is outputted, is facing one of the ends of the light guides 103.

Referring to FIG. 1D, the first embodiment of the present invention comprises six segments of light indicators arranged at the periphery of a space. In the space, a GPS-enabled device, such as a mobile phone having GPS-navigation capability or a portable navigation device (PND), particularly a display screen, can be provided. Varying numbers of light indicator segments may be implemented as well, and not limited to the exemplary 6 light indicator segments described, depending on the developer's requirements and specifications. The light indicator segments are further arranged so that the light emitted from its respective illuminating elements 102 lights up the corresponding light guides 103 only, and does not stray to the light guides 103 of other light indicator segments. The light indicator segments will then create signal patterns to its users, for example drivers of vehicles, so as to convey current position and navigation.

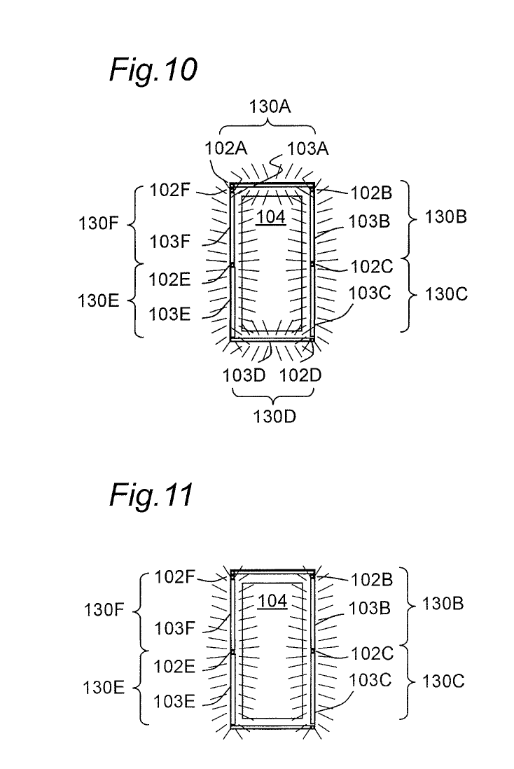

Alternatively, a plurality of illuminating elements 102 may be used instead of the light guide 103. These illuminating elements 102 are arranged in a linear alignment so as to produce a similar directional indication effect as that produced by the light indicator segment above. An example of this arrangement is illustrated in FIG. 10, using 5 illuminating elements 102.

### Second Embodiment

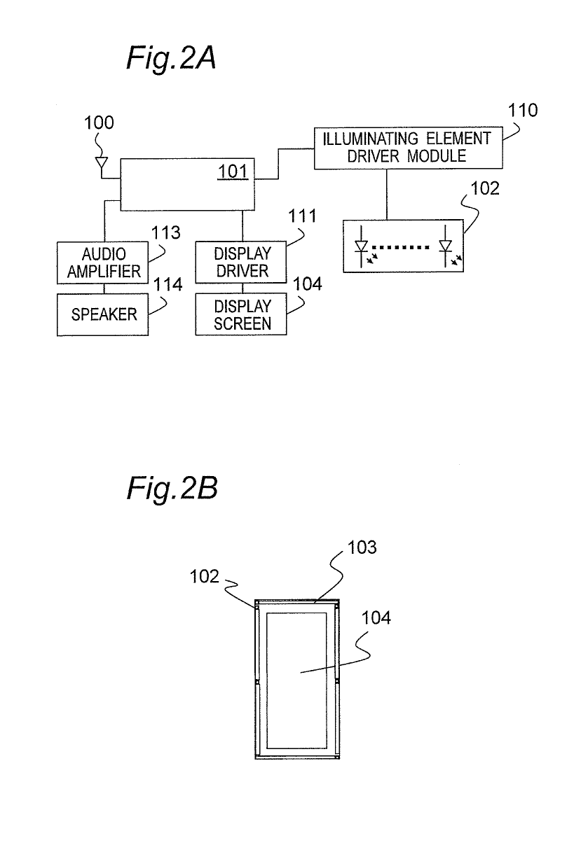

Referring to FIG. 2A, a second embodiment of the present invention is presented.

The second embodiment comprises the apparatus as described in the first embodiment, together with the addition of driver systems. The additional driver systems may exemplarily comprise at least one of or a combination of:

(1) A display system, comprising of a display driver 111 and display screen 104. The display screen 104 may be exemplarily implemented using liquid crystal displays (LCDs), Organic light-emitting diodes (OLEDs) or any appropriate display types. The display system is added so as to display more roads, traffic and other information from a pre-installed map in a memory. Also, the display system may be used to exemplarily implement the POI (point of interest) entry and verification component 104;

(2) An audio system, comprising of an audio amplifier 113 and a speaker 114. The audio system helps a user to navigate by providing audio direction indications;

(3) A separate illuminating element driver module 110, instead of the integrated driver module, to drive the illuminating elements 102. The illuminating element driver module 110, which is also referred to as an indicator driver, may be exemplarily implemented using an LED driver, where the illuminating elements 102 are LEDs, or a CCFL driver, where the illuminating elements 102 are CCFLs. The illuminating element driver module 110 gets driving information from GPS system 101. Based on the driving information, the illuminating element driver module 110 drives an appropriate illuminating element 102, hence providing a visual direction indication to the user.

Referring to FIG. 2B, the light indicator arrangement including a top indicator provided at a top side of a predetermined space at which the display screen 104 is provided, a right indicator provided at a right side of the screen 104, a left indicator provided at a left side of the screen 104, and a bottom indicator provided at a bottom of screen 104. The right indicator can have two segments, a first right indicator close to the top indicator and a second right indicator close to the bottom indicator. Similarly, the left indicator may have two segments, a first left indictor close to the top indicator and a second left indicator close to the bottom indicator.

### Third Embodiment

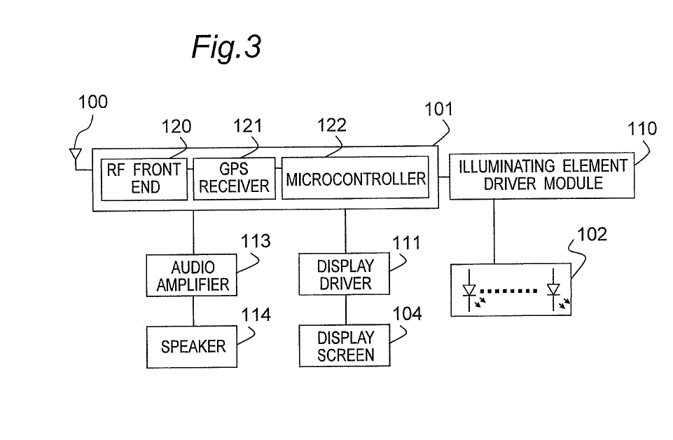

Referring to FIG. 3, a third embodiment of the present invention is presented. The GPS system 101 may be further comprised an RF front end 120, a GPS receiver 121 and microcontroller 122. The workings of the RF front end 120, a GPS receiver 121 and microcontroller 122 will be described as follows:

When satellite signals are captured by antenna 100, the signals go through the RF front end 120 for down conversion process. The output of the RF front end 120 is baseband IF (interface frequency). This baseband IF is then transferred into GPS receiver 121. The GPS receiver processor 121 is to detect or “lock” as many signals as possible from the output of the RF front end 120 and calculate the distance of the satellites to the earth. Once the distances of each satellite are determined, the GPS receiver 121 calculates the location on the earth through a complex algorithm. The result of the calculation is used by the microcontroller 122 to manipulate information at current location. The microcontroller uses pre-installed map information in its memory and suggests a navigation direction to a user when a position of destination is registered via the POI (point of interest) entry and verification component 104.

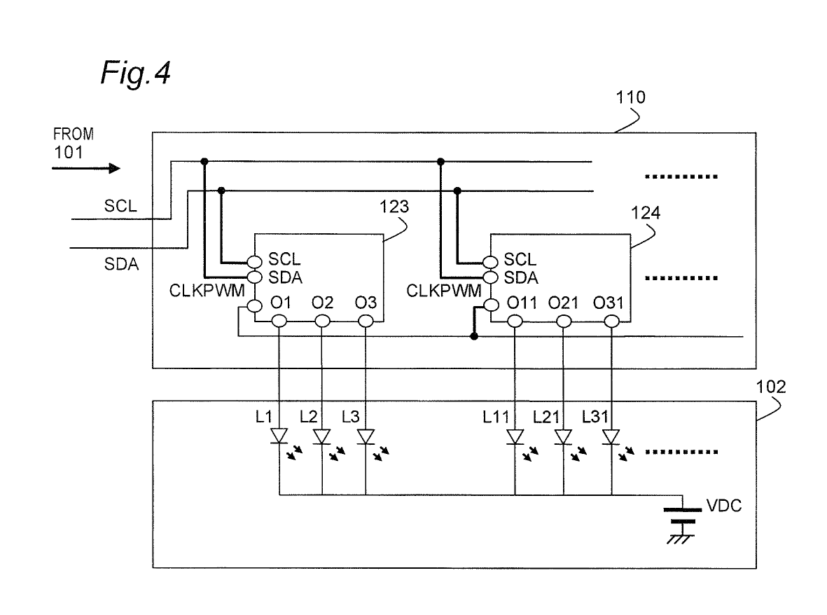

The illuminating element driver module 110 plays important role in navigation using light indicator. The illuminating element driver module 110 may be exemplarily implemented using an LED driver IC where it gets its driving instruction from microcontroller 122 via appropriate communication bus protocols, for example the Inter-IC communication (12C) protocol. FIG. 4 is an exemplary implementation of the illuminating element driver module 110.

In this exemplary implementation, light-emitting diodes (LEDs) are used to exemplarily implement the illuminating element 102. As LEDs are used here, the illuminating element driver module 110 may be exemplarily implemented by using an LED driver. For this example, as shown in FIG. 4, a typical LED driver 123 is an example of such. Communication with the GPS system 101 may be exemplarily implemented using the IIC bus protocol, represented by the SDA and SCL lines for data and clock synchronization purposes respectively. CLKPWM pin synchronizes between multiple LED drivers, for example when LED driver 123 is used with LED driver 124. Output pins O1, O2 and O3 provides the driving current for the LEDs L1, L2 and L3 respectively for LED driver 123; and pins O11, O21 and O31 provides the driving current for the LEDs L11, L21 and L31 respectively for LED driver 124. Through this exemplary arrangement, the GPS system 101 is able to give lighting instruction and control to each LED. A dedicated placement of the light indicator segment has to be designed correctly so that the indication of direction can be implemented accordingly. For example, the right turning LED must be placed at the indicator located at the right side of the GPS-enabled device. A directional pattern will be illuminated to the user for direction navigation purposes, as will be discussed later.

### Fourth Embodiment

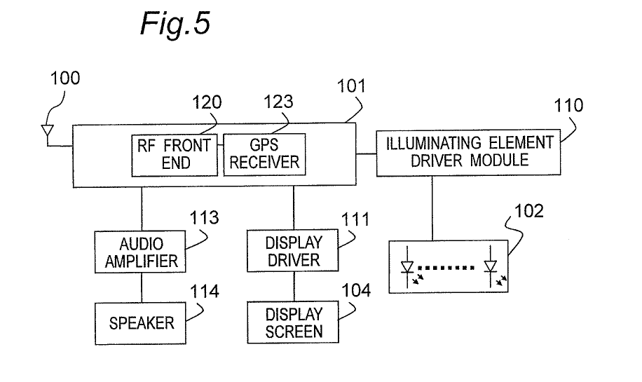

According to the fourth preferred embodiment of the present invention, GPS system 101 may comprise an RF front end 120 and a GPS processor 123 as illustrated in FIG. 5. In the fourth embodiment, the GPS processor 123 acts as an integrated version of the GPS receiver 121 and microcontroller 122 that are used in embodiment 3. As the functions of the components are essentially similar to that of the third embodiment, they will not be described again.

In FIGS. 1A, 2A, 3 and 5, the blocks taken together, but not including the illuminating element driver module 110 and the illuminating elements 102 is referred to as a GPS signal processor which produces information of navigation, such as a pointer indicating a position of the GPS signal processor on a displayed map. Furthermore, when a destination is entered in the GPS signal processor through a known procedure, the GPS signal processor produces a guide signal, such as a right turn signal for taking a right turn at a next road intersection, a left turn signal for taking a left turn at a next road intersection, or a forward signal for taking a straight forward at a next road intersection. The guide signal may also include at least any one of a U-turn signal for taking a U-turn at a next available place, an approaching signal for indicating that the GPS signal processor is approaching close to a destination, a bridge entry determination cycle signal indicating a decision to take a path leading to an overhead bridge when the road ahead has an overhead bridge, a tunnel entry determination cycle signal indicating a decision to take a path leading to an underground tunnel when the road ahead has an underground tunnel, a GPS lost signal when the GPS signal is lost, and a deviation signal when the GPS signal processor deviates from a calculated navigation path.

### Fifth Embodiment

According to the fifth preferred embodiment of the present invention, exemplary implementations of using the light indicator segments as a means of providing direction indication will be described. The light indicator segments will light up based on proximity of the device embodying the present invention to the desired destination, as well as when it approaches a junction where a decision has to be made, that is, what actions to take when the user meets the junction.

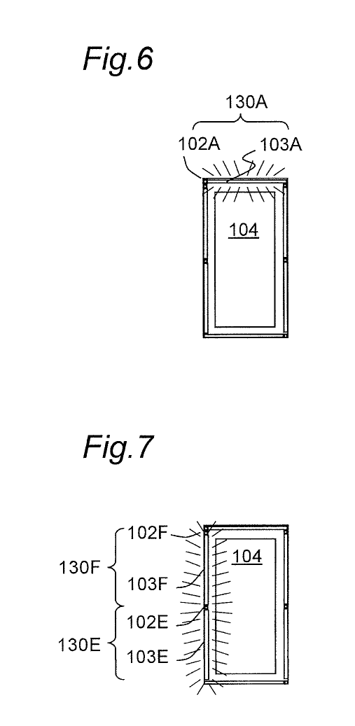

Referring to the FIG. 6, when navigation path is in the forward direction, the light indicator segment 130A, comprising of illuminating element 102A and light guide 103A and located at top/front of the GPS-enabled device lights up, in response to the forward signal, at a rate according to the distance between the device embodying the invention and the desired destination. An example of the light color emitted by the light indicator segment 130A would be green. When the device embodying the invention is within a first pre-determined distance away from a junction or the desired destination, the light indicator segment 130A fades in and out slowly. On the other hand, when the distance is getting shorter, the rate of fades in and out becomes higher. Finally, a steady light is emitted by light indicator segment 130A when the junction or destination is within a second pre-determined distance. An exemplary implementation of the first and second pre-determined distances are 1 kilometer and 10 meters respectively. To accomplish the above function, the illuminating element drive module 110 generates an ON-AND-OFF signal to activate the light indicator segments by a blinking effect. The frequency of the ON-AND-OFF signal changes relatively to a distance to a destination.

Accordingly, more intermediate steps may be included between the first and second pre-determined distances, with the light indicator segment 130A blinking at a higher rate as the device embodying the invention gets nearer to the junction or the desired destination.

Previous signalling method is applied to both left and right turns as well. For left turn, referring to FIG. 7, at least one light indicator segment on the left side of the device embodying the invention will light up in response to the left turn signal. An exemplary implementation is as shown, where light indicator segments 130E and 130F would light up. Light indicator segments 130E and 130F comprise illuminating elements 102E and 102F, and light guides 103E and 103F respectively. An example of the light color emitted by the light indicator segments 130E and 130F would be green.

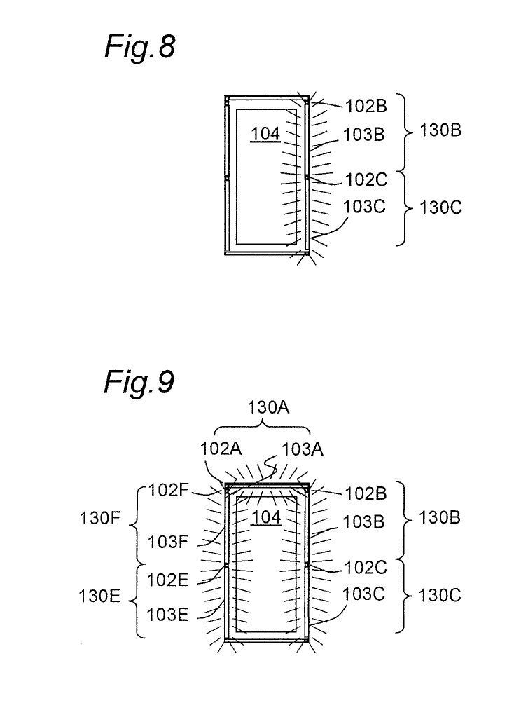

For right turn, referring to FIG. 8, at least one light indicator segment on the right side of the device embodying the present invention will light up in response to the right turn signal. An exemplary implementation is as shown, where light indicator segments 130B and 130C would light up. Light indicator segments 130B and 130C comprise illuminating elements 102B and 102C, and light guides 103B and 103C respectively. An example of the light color emitted by the light indicator segments 130B and 130C would be green.

For signaling to the user to make a U-turn, at least 3 light indicator segments may be used in response to the U-turn signal. The light indicator segments light up sequentially so as to produce a ‘running’ light effect.

For the case where U-turning on the right is required, the following steps are performed:

Firstly, at least a first light indicator segment on the left side of the device embodying the present invention will be turned on.

Secondly, after a first pre-determined period of time, the first light indicator will then turn off, and at least a second light indicator segment, located at the top of the device embodying the present invention, will turn on.

Thirdly, after a second pre-determined period of time, both the first and second light indicator segments will turn off, while at least a third light indicator segment, located on the right side of the device embodying the present invention, will turn on.

Fourthly, all 3 light indicator segments will then turn off after a third pre-determined period of time. The first, second and third pre-determined periods of time may have equal or different values with each other. The completion of the step four constitutes one ‘U-turn cycle’.

The ‘U-turn cycle’ would run continuously until the device embodying the present invention has reached the U-turn point.

Also, the speed of the ‘running’ light effect becomes faster as the device embodying the present invention approaches nearer to the U-turn point. When the device embodying the present invention is within a third pre-determined distance from the U-turn-point, a steady light will be emitted by the light indicator segments.

An exemplary implementation is as shown in FIG. 9, where the first light indicator segment on the left side of the device embodying the present invention may be exemplarily implemented by using the light indicator segment 130F; the second light indicator segment at the top of the device embodying the present invention may be implemented by using the light indicator segment 130A; the third light indicator segment on the right side of the device embodying the present invention may be exemplarily implemented by using the light indicator segment 130B. Yet another exemplary implementation would be using additional light indicator segments on the left side of the device embodying the present invention, implemented by using the light indicator segment 130E. Yet another exemplary implementation would be using additional light indicator segments on the right side of the device embodying the present invention, implemented by using the light indicator segment 130C.

Color tone, or brightness level, could also be changed to show the U-turn direction indication. For example, using the present exemplary implementation of FIG. 9, the color tones would vary from light indicator segment 130F to 130A to 130B, from lightest to darkest. Yet another exemplary implementation would be using additional light indicator segments on the left and right sides of the device embodying the present invention, that is, the color tones would vary from light indicator segment 130E to 130F to 130A to 1308 to 130C, from lightest to darkest.

U-turning on the right works in the same way as described for the U-turning on the left, but with the direction flow from light indicator segments 130B to 130A to 130F; and light indicator segment 130C to 130B to 130A to 130F to 130E for exemplary implementation using additional light indicator segments on the left and right sides of the device embodying the present invention.

For signaling to the user to take the overhead bridge or to continue along the current road, the steps to perform will be described in the following paragraphs.

If the decision is to get onto the overhead bridge, i.e., in response to the bridge entry determination cycle signal, the following lighting operation takes place, as described with reference to FIG. 10:

Firstly, light indicator segments 130E and 130C will turn on, while all other light indicator segments are off.

Secondly, after a fourth pre-determined period of time, light indicator segments 130E and 130C will turn off, and light indicator segments 130F and 130B will turn on.

Thirdly, after a fifth pre-determined period of time, light indicator segments 130F and 130B will turn off, and light indicator segment 130A will turn on.

Fourthly, after a sixth pre-determined period of time, light indicator segment 130A will turn off. The completion of the step four constitutes one ‘bridge entry determination cycle’. The fourth, fifth and sixth pre-determined periods of time may have equal or different values with each other.

The period of the ‘bridge entry determination cycle’ is reduced as the device embodying the present invention approaches the entry to the overhead bridge.

If the decision is to continue along the current road, the earlier described sequence for navigation in the forward direction will be used.

An example of the light color emitted by the light indicator segments would be green.

For signaling to the user to take the underground tunnel or to continue along the current road, the steps to perform will be described in the following paragraphs.

If the decision is to get into the underground tunnel, i.e., in response to the tunnel entry determination cycle signal, the following lighting operation takes place, as described with reference to FIG. 10.

Firstly, light indicator segments 130F and 130B will turn on, while all other light indicator segments are off.

Secondly, after a seventh pre-determined period of time, light indicator segments 130F and 130B will turn off, and light indicator segments 130E and 130C will turn on.

Thirdly, after an eighth pre-determined period of time, light indicator segments 130E and 130C will turn off, and light indicator segment 130D will turn on.

Fourthly, after a ninth pre-determined period of time, light indicator segment 130D will turn off. The completion of the step four constitutes one ‘tunnel entry determination cycle’.

The period of the ‘tunnel entry determination cycle’ is reduced as the device embodying the present invention approaches the entry to the underground tunnel.

If the decision is to continue along the current road, the earlier described sequence for navigation in the forward direction will be used.

An example of the light color emitted by the light indicator segments would be green. Yet another exemplary implementation would be to have a different light color emitted by light indicator segment 130D from the other light indicator segments, to indicate an entrance to under-the-ground level.

For signaling to the user an indication that the GPS signal is lost, due to present ambient conditions or other reasons, the steps to perform will be described in the following paragraph.

In response to the GPS lost signal, light indicator segments on the left and right sides of the device embodying the present invention will blink continuously. Referring to FIG. 11, an exemplary implementation would be blinking of light indicator segments 130F, 130B, 130E and 130C. Example of color to be used for the light indicator segments would be red, which would indicate an alarm.

For signaling to the user an indication that the device embodying the invention has gone out of the proposed navigation paths, due to user decision to take a different path, or has mistakenly taken a wrong path, or due to other reasons, the steps to perform will be described in the following paragraph.

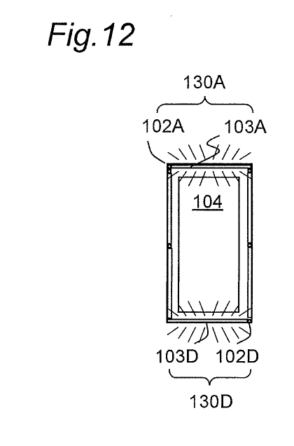

In response to the deviation signal, light indicator segments on the top and bottom sides of the device embodying the present invention will emit a steady light. Referring to FIG. 12, an exemplary implementation of this would be the emitting of steady light by light indicator segments 130A and 130D. Example of color to be used for the light indicator segments would be red, which would indicate an alarm.

1. An apparatus for providing directional navigation indication using a GPS signal, comprising:
a GPS signal processor which produces a guide signal including a forward signal for indicating a straight forward at a next road intersection, a right turn signal for indicating a right turn at a next road intersection, and a left turn signal for indicating a left turn at a next road intersection;
a light indicator arrangement including a top indicator provided at a top side of a predetermined space, a right indicator provided at a right side of said predetermined space, and a left indicator provided at a left side of said predetermined space; and
an indicator driver which controls the driving of said light indicator arrangement in such a manner that, said top indicator is activated in response to said forward signal, said right indicator is activated in response to said right turn signal, and said left indicator is activated in response to said left turn signal.

2. The apparatus according to claim 1, wherein said guide signal further including a U-turn signal for indicating a U-turn at a next available place, and wherein said indicator driver controls the driving of said light indicator arrangement in such a manner that said right indicator, said top indicator and said left indicator are activated sequentially in response to said U-turn signal to produce a running light effect through said right indicator, top indicator and left indicator.

3. The apparatus according to claim 2, wherein said running light effect becomes faster as the GPS signal processor approaches close to said next available place.

4. The apparatus according to claim 3, wherein said running light effect becomes steady light when said GPS signal processor reaches said next available place.

5. The apparatus according to claim 1, wherein said light indicator arrangement comprises an illuminating element which emits light, and a light guide placed in proximity to said illuminating element to guide light from said illuminating element to produce a light distribution effect.

6. The apparatus according to claim 1, wherein said light indicator arrangement comprises a plurality of illuminating elements aligned in a line.

7. The apparatus according to claim 1, wherein said illuminating element comprises a light-emitting diode or a cold cathode fluorescent lamp.

8. The apparatus according to claim 1, further comprising a display screen which is located in said predetermined space.

9. The apparatus according to claim 1, wherein said guide signal further includes an approaching signal for indicating that the GPS signal processor is approaching close to a destination, and wherein said indicator driver controls the driving of said light indicator arrangement in such a manner that said light indicator arrangement produces fade in and out effect in response to said approaching signal.

10. The apparatus according to claim 1, wherein said indicator driver generates an ON-AND-OFF signal to activate said light indicator arrangement by a blinking effect, and wherein a frequency of the ON-AND-OFF signal changes relatively to a distance to a destination.

11. The apparatus according to claim 1, wherein said indicator driver controls said light indicator arrangement to change the color tone.

12. The apparatus according to claim 1, wherein said light indicator arrangement further including a bottom indicator provided at a bottom side of said predetermined space.

13. The apparatus according to claim 12, wherein said right indicator is divided into a first right indicator close to the top indicator and a second right indicator close to the bottom indicator, and wherein said left indicator is divided into a first left indictor close to the top indicator and a second left indicator close to the bottom indicator.

14. The apparatus according to claim 13, wherein said guide signal further includes a bridge entry determination cycle signal indicating a decision to take a path leading to an overhead bridge when the road ahead has an overhead bridge, and wherein said indicator driver controls the driving of said light indicator arrangement in such a manner that said second right indicator and said second left indicator are activated simultaneously, and thereafter, said first right indicator and said first left indicator are activated simultaneously, and thereafter, said top indicator is activated, in response to said bridge entry determination cycle signal.

15. The apparatus according to claim 13, wherein said guide signal further includes a tunnel entry determination cycle signal indicating a decision to take a path leading to an underground tunnel when the road ahead has an underground tunnel, and wherein said indicator driver controls the driving of said light indicator arrangement in such a manner that said first right indicator and said first left indicator are activated simultaneously, and thereafter, said second right indicator and said second left indicator are activated simultaneously, and thereafter, said bottom indicator is activated, in response to said tunnel entry determination cycle signal.

16. The apparatus according to claim 13, wherein said guide signal further includes a GPS lost signal when the GPS signal is lost, and wherein said indicator driver controls the driving of said light indicator arrangement in such a manner to blink said light indicator arrangement in response to said GPS lost signal.

17. The apparatus according to claim 16, wherein said first left indicator and said first right indicator of said light indicator arrangement are driven to produce blinking light.

18. The apparatus according to claim 13, wherein said guide signal further includes a deviation signal when the GPS signal processor deviates from a calculated navigation path, and wherein said indicator driver controls the driving of said light indicator arrangement in such a manner to emit steady light from said light indicator arrangement in response to said deviation signal.

19. The apparatus according to claim 18, wherein said top indicator and said bottom indicator of said light indicator arrangement are driven to produce steady light.

20. A method for providing directional navigation indication using a GPS signal, comprising:
processing a GPS signal to produce a guide signal including a forward signal for indicating a straight forward at a next road intersection, a right turn signal for indicating a right turn at a next road intersection, and a left turn signal for indicating a left turn at a next road intersection;
arranging light indicators including a top indicator provided at a top side of a predetermined space, a right indicator provided at a right side of said predetermined space, and a left indicator provided at a left side of said predetermined space; and
controlling the light indicators in such a manner that, said top indicator is activated in response to said forward signal, said right indicator is activated in response to said right turn signal, and said left indicator is activated in response to said left turn signal.
